(19) United States
(12) Patent Application Publication
(10) Pub. No.: US 2014/0198505 A1
(43) Pub. Date: Jul. 17, 2014

(54) LED Flexible Hanging Display Screen

(71) Applicant: Dong-min Yan, Guangdong (CN)

(72) Inventor: Dong-min Yan, Guangdong (CN)

(73) Assignee: Guangzhou Night-Rainbow Photoelectric Technology Development Co., Ltd., Guangdong (CN)

(21) Appl. No.: 14/238,400

(22) PCT Filed: Aug. 10, 2012
(86) PCT No.: PCT/CN2012/079988

§ 371 Date: Feb. 11, 2014

(30) Foreign Application Priority Data
Aug. 12, 2011 (CN) 201120292854.3

(51) Int. Cl. F21K 99/00

(52) U.S. Cl. CPC F21K 9/30
USPC 362/249.04

(57) ABSTRACT

An LED flexible hanging display screen comprises several discrete LED modules (1) and a flexible mesh (2). The LED modules (1) are arrange and fixed on the flexible mesh (2) in matrix form. Adjacent LED modules (1) have equal distances transversely and longitudinally. Compared with the original fixed rigid box structure, the present invention is more permeable and is capable of withstanding strong winds. The discrete structures of the LED module are easy to be fixed on the mesh and are capable of being fixed fast, and an individual module is capable of repaired or replaced easily when damaged during use, and a display screen fabricated thereof has a low cost and high fabrication speed. The present invention is particularly suitable for dynamic display at temporary sites for festivals, holidays, ceremonies, commercial promotions.

### FIELD OF THE INVENTION

This utility model involves a light emitting diode (LED) Display, specifically a flexible mesh type LED display that can be rolled up or hung up.

### BACKGROUND

Light emitting diodes are widely used in lighting and display areas nowadays. Its application in display technology is realized through manufacturing of various types of display screens based on LED matrix modules. Such screens are able to display all kinds of dynamic and changing texts, patterns, animations and graphics resulting in effective communication of all kinds of information.

Most current LED displays are of a rigid fixed structure. Manufacturing of such displays typically involves producing a rigid box-style casing first, and then the LED matrix circuit boards and control circuits will be installed inside the box. The LED matrix circuit boards are usually made of rigid materials. Displays made with such components can only be fixed in one place, and they are bulky and heavy, inconvenient to transport and impossible to roll or fold up. On-site installation and testing of such displays are time consuming and must be operated by trained professionals. Rigid displays entail high manufacturing and installation costs and they are restricted to being used in a fixed location. Such regular rigid displays are evidently not suited to locations that need temporary displays for a short period of time.

### SUMMARY

The objective of this utility model is offer a new utility and overcomes technical limitations of the existing technology. This utility model provides a flexible mesh style display that is light, can be rolled up or folded, permeable and windproof, ready for fast installation and removal, easy to transport because of its small size, convenient for hanging up and requires low production cost.

In order to achieve the aforesaid objective, this utility model employs the technical solution of a flexible hung-up LED display. It includes numerous discreet LED modules and a flexible mesh, wherein said LED modules are fastened to said flexible mesh in a matrix pattern at equal intervals both horizontally and vertically. The overall pattern formed by the LED modules fastened to the mesh can either be rectangular or other different shapes. Said LED modules can be tri-color RGB modules or single color modules.

Said LED module contains a control chip and multiple light emitting diodes (LED) connected to it.

Said flexible hung-up LED display further includes a program controller and external power supply, the latter is connected to said program controller and LED modules, and said program controller is connected to the LED modules.

Said flexible mesh is made of flame retardant plastic materials.

Compared to the technology of the current ridged box-style products, this utility model fastens discreet LED modules to light weight and flexible meshes. The displays are prefabricated in the factory and no on-sited production is necessary. The mesh made of flame retardant plastics is light and easy to roll up for convenient transportation and storage. No deformation of the modules will occur when the mesh is unrolled. Installation can be performed by non-professionals by just hanging the display up on the face of a building or structure. This substantially increases applications of the displays making it especially suitable for locations of temporary outdoor advertising and lighting decorations. The mesh structure is more permeable and thus resistant to strong wind hazards compared to conventional rigid box structure. The discreet structure of the LED modules makes it convenient to fasten them to the mesh in a speedy manner, and occasional damaged modules can be easily repaired or replaced. Production cost of such displays is low. This utility model especially suits the temporary dynamic display needs in holiday celebrations and commercial promotional events.

### DRAWING DESCRIPTION

The following further provides detail description of this utility model using the drawing.

FIG. 1 is a structural diagram of this utility model

### DETAIL DESCRIPTION OF THE INVENTION

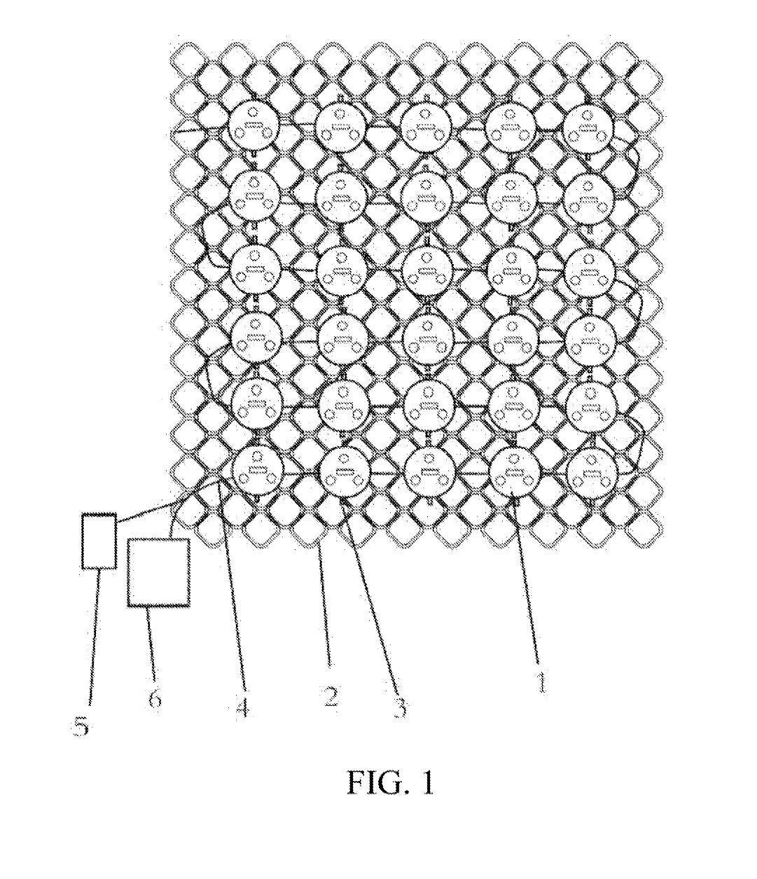

FIG. 1 is an implementation example of flexible LED display that contains discreet LED modules—1; a flexible plastic mesh—2; tie down fasteners—3; connecting cables (power and control cables)—4; an external power supply—5 and a program controller—6.

Discreet LED modules—1 are fastened to the flexible plastic mesh—2 in a certain pattern (rectangle or other patterns) and tied down using the tie down fasteners—3, the LED modules are spaced out at equal intervals both horizontally and vertically. Displays made of numerous LED modules—1 can be in rectangular or other different shapes. An LED module—1 is a combination of a plastic casing, a light emitting diode set, a control chip, capacitor and resistor and injection molded plastic part.

A plurality of LED modules—1 fastened to a flexible plastic mesh are connected to each other via multiple cables—4 (power and control cables) forming electrical connections. The power supply cables provide power needed for light emission while the control cables send display changing signals to the LED modules.

Said flexible plastic mesh—2 is made of flame retardant plastics with top safety performance being fireproof and electrically non-conductive. It not only possesses a certain level of softness but also toughness and strength and it is also light in weight. This means that the mesh can be rolled up to reduce its size for easy transportation and storage, and spread out to show the rectangular pattern formed by the LED modules when using. The strength and high toughness of the mesh guarantees that rolling-up and spreading will not result in damages such ruptures or deformation.

When the LED matrix modules are connected to said power supply and program controller, the matrix modules tied down to the flexible mesh will display all kinds of different patterns and graphics according to the signals it they receive from the program controller—6.

The discreet LED modules are attached to and distributed over the mesh individually making it, possible to roll up the combined product of the LED modules and flexible mesh into a roll, this reduces its size for convenient transportation and storage and it can be unrolled easily and hung up for use.

The unique structure of this display makes it possible for concentrated speed production at the factory (fastening and connecting cables), easy on-site installation and removal and convenient transportation without causing damages easily.

Notwithstanding the description of this utility model is based on an actual example, the description does not constitute any limitations or restrictions on this utility model. Variations of the disclosed example according to the description of this utility model are expected of technical personnel in this field. Hence such variations should not be excluded from the scope and spirit defined under the patent claims.

What is claimed is:

1. A type of flexible hung-up LED Display comprising numerous LED (light emitting diode) modules and a flexible mesh. It is characterized in that said LED modules are fastened to said flexible mesh at equal intervals both horizontally and vertically.

2. A flexible hung-up LED display according to claim 1 wherein said LED module contains a control chip and multiple light emitting diodes connected to the chip.

3. A flexible hung-up LED display according to claim 1 wherein it further contains a control program and an external power supply connected to the program controller and LED modules respectively, said program controller is connected to said LED modules.

4. A flexible hung-up LED display according to claim 1 wherein said flexible mesh is made of flame retardant plastics.
